(19) United States
(12) Patent Application Publication
(10) Pub. No.: US 2026/0095891 A1
(43) Pub. Date: Apr. 2, 2026

(54) LOCAL UTC UPDATE BASED ON CELLULAR COMMUNICATION NETWORK PAGING SUBFRAMES

(71) Applicant: Itron, Inc., Liberty Lake, WA (US)

(72) Inventors: Thomas Uhling, Spokane Valley, WA (US); Keith Barnes, Waseca, MN (US); Imad Jamil, Meudon (FR)

(21) Appl. No.: 18/899,144

(22) Filed: Sep. 27, 2024

(51) Int. Cl. H04W 68/02; H04W 76/28

(52) U.S. Cl. CPC H04W 68/02; H04W 76/28

(57) ABSTRACT

A method, a device, and non-transitory computer-readable storage medium are directed to synchronizing a local UTC of the device, operating in a cellular communication network, with the UTC, and includes monitoring for paging subframes transmitted at a paging subframe repeat interval; receiving the paging subframes; generating, based at least in part on the paging subframes received, paging triggers having a paging trigger repeat interval equal to the paging subframe repeat interval; and adjusting a reference timer of the electronic device based at least in part on the paging triggers.

### TECHNICAL FIELD

The present disclosure generally relates to the field of reference time correction, and more specifically to a system and method for correcting coordinated universal time (UTC) of an electronic device using a paging subframe of a cellular communication network.

### BACKGROUND

A modern electronic device often requires a precise reference time, or clock, to synchronize with various internal and external events, such as correct timing for receiving and transmitting data. For an electronic communication device, such as a user equipment (UE) operable in a cellular communication network, a reference time may be provided by, or based on, synchronizing to an accurate external timing source, such as the global positioning system (GPS) timing source and/or the Coordinated Universal Time (UTC). A cellular communication network provides UTC information to a UE for synchronizing to the UTC every time the UE registers to the cellular communication network.

After the UE is registered, the cellular communication network may optionally provide GPS time and UTC information the UEs by broadcasting System Information block 16 (SIB16) that includes GPS time and UTC information. However, because it is optional, the UE cannot always rely on SIB16 being available from the cellular communication network to which the UE has registered. If SIB16 is not available, the UE will be forced to re-register to the cellular communication network, which requires additional energy consumption, to update its synchronization to the UTC. While a network time protocol (NTP) client may be installed on the UE, and the UE may obtain accurate UTC time from a publicly available NTP server, running the NTP client also requires additional messaging, code, memory resources, and energy consumption.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment in which a local UTC of a user equipment (UE) may be updated based on paging subframes transmitted from a base station.

FIG. 2 is a schematic diagram illustrating a UE updating a local coordinated universal time (UTC) of the UE to the UTC.

FIG. 3 illustrates an example flowchart of updating a local UTC of a UE based on paging subframes.

FIG. 4 illustrates details of one of blocks of FIG. 3.

FIG. 5 illustrates details of another block of FIG. 3.

FIG. 6 is a block diagram of a UE in a cellular communication network environment.

### DETAILED DESCRIPTION

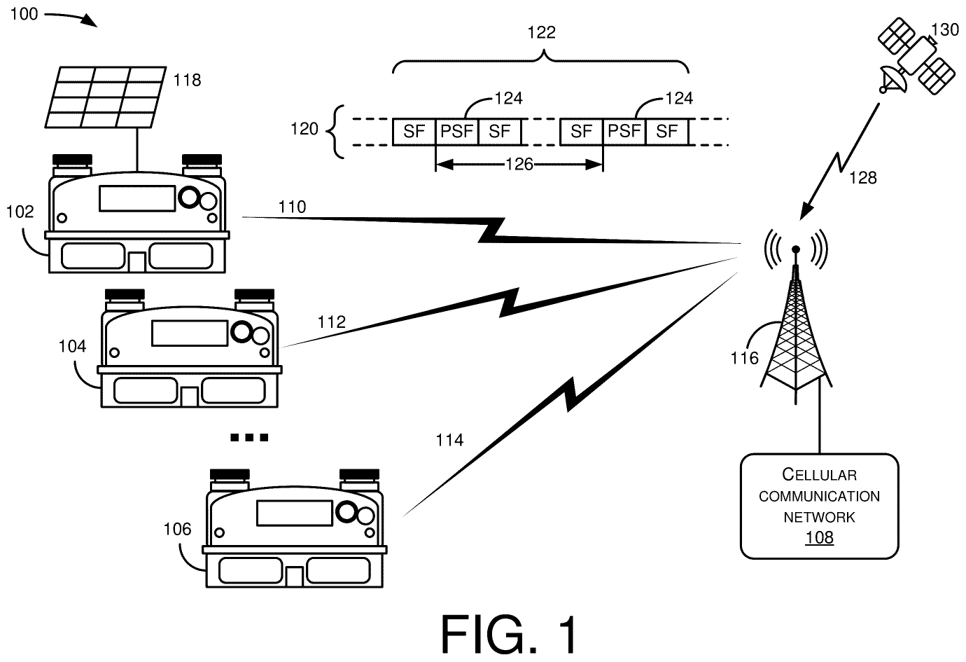

FIG. 1 illustrates an example environment 100 in which a local UTC of a user equipment (UE), operating in a cellular communication network, may be updated based on paging subframes transmitted from a base station. A UE may include a battery powered device (BPD) and a mains powered device, such as a metering device, a monitoring device, a communication device, or any other type of an electronic device electrically powered by mains power, a battery, and/or a local external power source, such as a solar panel, a fuel cell, a windmill, and the like, and operates in a cellular communication network. For example, a mains powered device may comprise a battery for powering the mains powered device during a blackout, and a BPD may comprise a solar panel to charge its battery. In this example, BPDs are illustrated as examples of the UEs. A plurality of BPDs, such as a first BPD 102, a second BPD 104, and a third BPD 106 shown as examples of UEs, may register to a cellular communication network 108 by communicating, shown by arrows 110, 112, and 114, with a base station 116 as an access point for the cellular communication network 108. A BPD includes one or more batteries and may be powered at least in part by a solar panel 118 as shown with the first BPD 102 or other power supply or generator, such as a fuel cell, wind power, thermal power, and the like. It is to be understood that a description pertaining to one UE or BPD, such as the first BPD 102, may be applicable to any or all of UEs, such as the first BPD 102, the second BPD 104, and the third BPD 106. The base station 116 may transmit paging frames 120, each paging frame 120 containing multiple subframes 122 including a paging subframe 124 at a paging subframe repeat interval 126. The paging subframes 124 may be, or include, paging occasions within which the first BPD 102, the second BPD 104, and/or the third BPD 106 wake up to receive paging information, if any, from the cellular communication network 108. The paging subframes 124, and paging occasions, transmitted by the cellular communication network 108 are locked to a Global Positioning System (GPS) time 128 provided from a satellite 130, and thus have an accurate time of the GPS time 128 that is in synchronization with the coordinated universal time (UTC) and the paging subframe repeat interval 126 from the base station 116 is precisely timed. Upon registration to the cellular communication network 108, internal clocks, or reference timers, of the first BPD 102, the second BPD 104, and the third BPD 106 may also be synchronized to the GPS time 128 thereby synchronizing to the UTC.

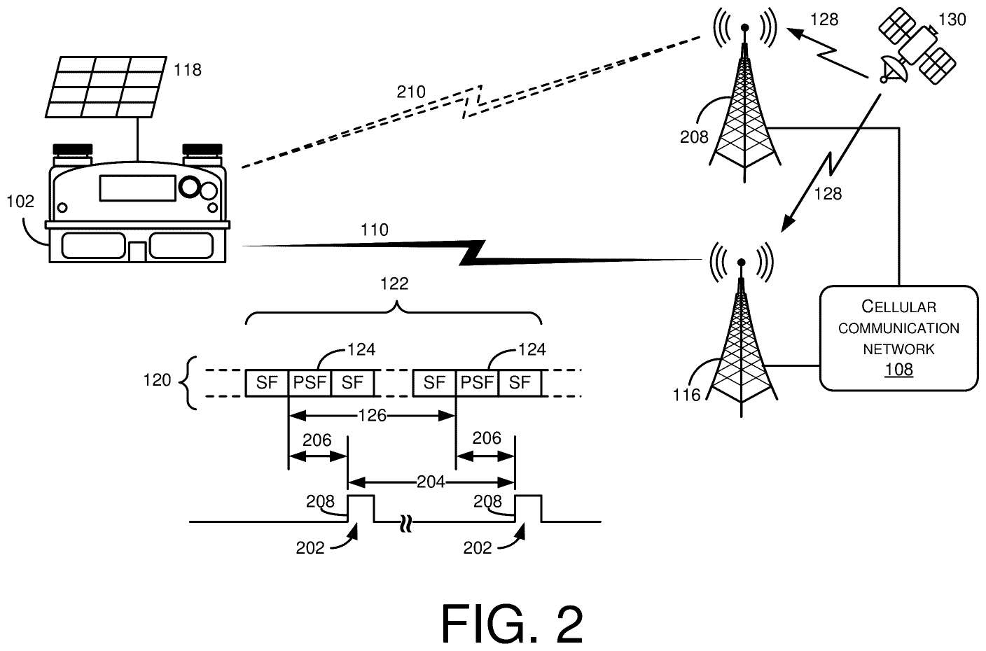

FIG. 2 is a schematic diagram illustrating a BPD, such as the first BPD 102, updating a local coordinated universal time (UTC) of the first BPD 102 to the UTC. As described above with reference to FIG. 1, the first BPD 102 may register to the cellular communication network 108 by communicating with, as shown by arrow 110, the base station 116 that transmits the paging frames 120, receive the UTC information, and synchronize the local UTC of the first BPD 102 with the UTC. In response to registering to the cellular communication network 108, the first BPD 102 may receive from the base station 116 discontinuous reception (DRX) parameters associated with operating the first BPD 102 with the base station 116 to reduce power consumption by enabling the first BPD 102 to be inactive during a portion of the paging frames 120. The DRX mode determines how frequently, or infrequently, the first BPD 102 wakes up and checks for the paging subframes 124 of the multiple subframes 122. The DRX parameters may include the paging subframe repeat interval 126, a paging time window (PTW) duration that spans one or more paging subframe repeat intervals 126, a number, n, of paging subframes 124 included in the PTW, and other parameters.

The first BPD 102 may alternatively begin operating in enhanced DRX mode with eDRX parameters similar to the DRX parameters received from the base station 116 upon registration, which is designed to further save power consumption of the first BPD 102 by placing the first BPD 102 in an inactive, or sleep, mode and by only being partially active, or awake, at a predetermined period. For example, the eDRX mode may enable the first BPD 102 to monitor for certain subframes, such as the paging subframes 124, without fully booting by waking up at the paging subframe repeat interval 126, such as an eDRX cycle communicated to the first BPD 102 from the base station 116 upon registration, receive and/or identify the paging subframes 124, and determine whether to be fully active, or booting, to decode data in the paging subframes 124. However, while the timing of the paging subframe repeat interval 126 is maintained, or timed, based on the GPS time 128 from the satellite 130 and thus precise and accurate, clocking, or timing, of internal events of the first BPD 102 is maintained by the reference timer of the first BPD 102, which may drift over time, and the local UTC maintained by the reference timer may no longer be synchronized with the GPS time 128 and/or the UTC.

Based at least in part on the paging subframes 124 received, the first BPD 102 may generate paging triggers 202. Because the first BPD 102 generates a paging trigger 202 each time the first BPD 102 receives and identifies a paging subframe 124, the paging triggers 202 have a paging trigger repeat interval 204 equal to the paging subframe repeat interval 126 of the paging subframes 124 from the base station 116. As indicated by the paging subframe repeat interval 126, the paging triggers 202 are generated relative to the beginning of the paging subframes 124. Because the paging subframes 124 are locked to the GPS time 128 and have the accurate time of the GPS time 128, as discussed above with reference to FIG. 1, the timing of the paging triggers 202 is equally accurate and precise. However, because it takes a certain amount of time to generate a paging trigger 202 from the time the paging subframe 124 is received and identified, there is a trigger delay 206 between the beginning of the paging subframe 124 a beginning, or a rising edge 208, of the paging trigger 202. While the trigger delay 206 may be caused due to characteristics of components of the first BPD 102 and a processing time associated with identifying the paging subframe 124 and generating the paging trigger 202, the trigger delay 206 does not change from one paging subframe 124 to another paging subframe 124, and may be set to a constant value. For example, the trigger delay 206 may be measured and stored in the first BPD 102 during a testing before the first BPD 102 is installed in the field. The trigger delay 206 is, therefore, predetermined. For each paging subframe 124 received and identified, the first BPD 102 may timestamp the corresponding paging trigger 202 with a trigger time, or a timestamp. Based on the trigger time and the trigger delay 206, the first BPD 102 may determine a paging subframe reception time of the associated paging subframe 124.

As described above with reference to FIG. 1, while the reference timer of the first BPD 102 may initially be synchronized to the UTC upon registration to the cellular communication network 108, the reference timer may drift over time, that is, the first BPD 102 may become out of synchronization with the GPS time 128 and/or the UTC over time. By generating the paging triggers 202 based at least in part on the paging subframes 124, the first BPD 102 may adjust, or correct, the reference timer of the first BPD 102 to synchronize with the UTC based at least in part on the paging triggers 202.

Based on changes in the conditions associated with the base station 116, the cellular communication network 108 may require the first BPD 102 to switch from the base station 116, which the first BPD 102 initially accessed to register to the cellular communication network 108, to another, or a different, base station 208, as shown by dotted arrow 210. For example, the network traffic for the base station 116 may be approaching a maximum capacity and the some of the network traffic may need to be routed to a different base station, such as the other base station 208, the quality of signal (QoS) associated with the base station 116 is lower than the QoS associated with the other base station 208, the signal strength associated with the base station 116 is lower than the signal strength associated with the other base station 208, etc. In response to switching from the base station 116 to the other base station 208, or in response to detecting a change of the access point from the base station 116 to the other base station 208, the first BPD 102 may generate an indication of the change including new DRX, or eDRX, parameters associated with the other base station 208 received from the other base station 208. The first BPD 102 may continue operating in the DRX, or eDRX, mode now with the new eDRX parameters.

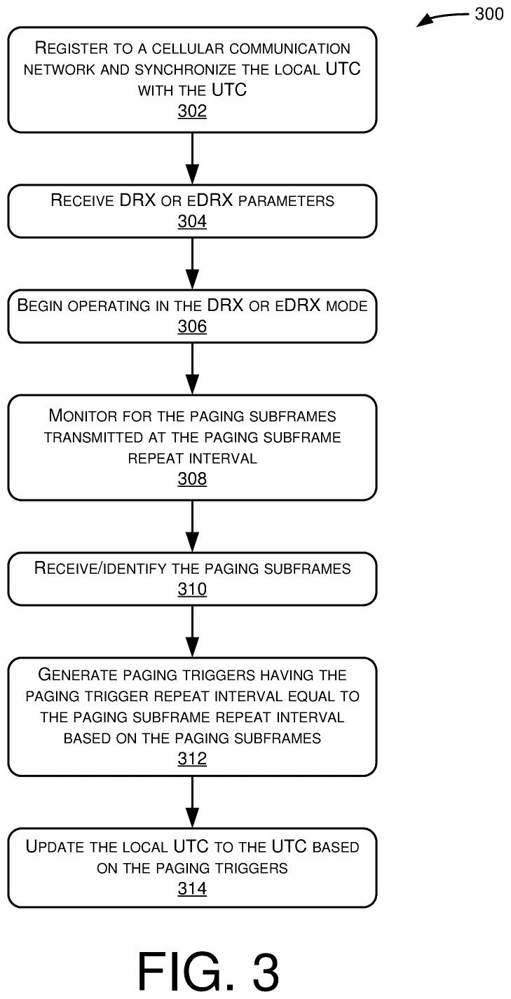

FIG. 3 illustrates an example flowchart 300 of updating a local UTC of a UE, such as the first BPD 102, based on paging subframes, such as the paging subframes 124. Prior to monitoring paging subframes 124 transmitted from a base station, such as the base station 116, the first BPD 102 may register to a cellular communication network, such as the cellular communication network 108, by communicating with the base station 116 that transmits paging frames 120 including the paging subframes 124 at block 302. For example, the first BPD 102 may communicate with the base station 116, that transmits the paging frames 120, as an access point to register to the cellular communication network 108, receive the UTC information, and synchronize the local UTC of the first BPD 102 with the UTC. In response to registering to the cellular communication network 108, the first BPD 102 may receive from the base station 116 at block 304 the DRX parameters associated with operating the first BPD 102 in the DRX mode with the base station 116 as described above with reference to FIG. 2. The first BPD 102 may then begin operating in the DRX mode at block 306. As described above with reference to FIG. 2, the DRX mode includes the eDRX, the first BPD 102 may alternatively receive the eDRX parameters from the base station 116 and operate in the eDRX mode.

As described above with reference to FIG. 2, the DRX mode and eDRX mode are designed to save battery power by placing the first BPD 102 in an inactive, or sleep, mode and by only being partially active, or awake, at a predetermined period. For example, in the eDRX mode, the first BPD 102 may be able to monitor for certain subframes, such as the paging subframes 124, without fully booting by waking up to be available at the paging subframe repeat interval 126, such as a DRX, or eDRX, cycle communicated to the first BPD 102 from the base station 116 upon registration, receive and/or identify the paging subframes 124, and determine whether to be fully active, or booting, to decode data in the paging subframe 124.

At block 308, the first BPD 102 may monitor for the paging subframes 124 transmitted at the paging subframe repeat interval 126, and receive and/or identify the paging subframes 124 at block 310. However, while the timing of the paging subframe repeat interval 126 is maintained, or timed, based on the GPS time 128 and thus precise and accurate, clocking, or timing, of internal events of the first BPD 102 is maintained by the reference timer of the first BPD 102, which may drift over time, and the local UTC maintained by the reference timer may no longer be synchronized with the GPS time 128 and/or the UTC. Based at least in part on the paging subframes 124 received, the first BPD 102 may generate paging triggers 202 having the paging trigger repeat interval 204 equal to the paging subframe repeat interval 126 at block 312. As described above with reference to FIGS. 1 and 2, because the first BPD 102 generates a paging trigger 202 each time the first BPD 102 receives and identifies a paging subframe 124 that is locked to the GPS time 128, the paging triggers 202 have a paging trigger repeat interval 204 equal to the paging subframe repeat interval 126 of the paging subframes 124 and accuracy of the GPS time 128. At block 314, the first BPD 102 may adjust, or correct, a reference timer, such as a reference timer, of the first BPD 102 based at least in part on the paging triggers 202, which includes updating a local UTC of the reference timer of the first BPD 102 to the UTC.

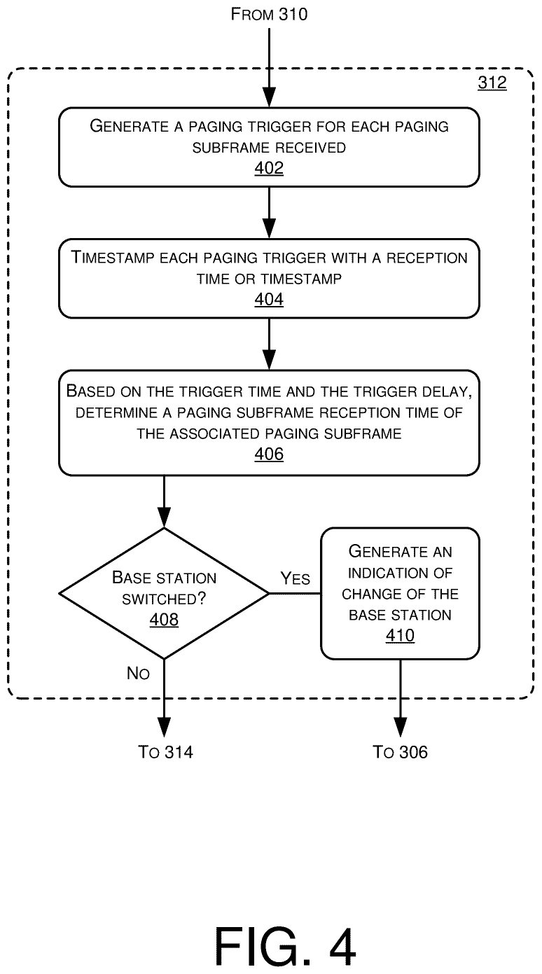

FIG. 4 illustrates example details of block 312 of FIG. 3. As discussed above with FIG. 2, in response to registering to the cellular communication network 108, the first BPD 102 may receive the DRX, or eDRX, parameters including the paging subframe repeat interval 126 of the paging subframes 124, the PTW duration that spans one or more paging subframe repeat intervals 126, the number, n, of paging subframes 124 included in the PTW, and other parameters from the base station 116. At block 402, based at least in part on the paging subframes 124 received, the first BPD 102 may generate a paging trigger 202 for each paging subframe 124 received. For each paging subframe 124 received and identified, the first BPD 102 may timestamp the paging trigger 202 with a trigger time, or a timestamp at block 404. Based on the trigger time and the trigger delay 206, the first BPD 102 may determine a paging subframe reception time of the associated paging subframe 124 at block 406.

At block 408, the first BPD 102 may determine whether the base station, through which the first BPD 102 accesses the cellular communication network 108, is switched from the base station 116 to a different base station, such as the other base station 208. For example, the cellular communication network 108 may require the first BPD 102 to switch the base station for the situations described above with reference to FIG. 2. If the first BPD 102 determines that the base station has not been switched (“NO” branch), then the process proceeds to block 314. If the first BPD 102 determines that the base station has been switched (“YES” branch), the first BPD 102 may generate an indication of the change of the base station at block 410, and the process loops back to block 306, where the first BPD 102 may repeat the process with the other base station 208 with new DRX, or eDRX, parameters associated with the other base station 208, which may additionally include an offset representing a difference between the timing base of the base station 116 and the timing base of the other base station 208. A value for the offset is typically non-zero if the base station 116 and the other base station are located in different tracking areas of the cellular communication network 108.

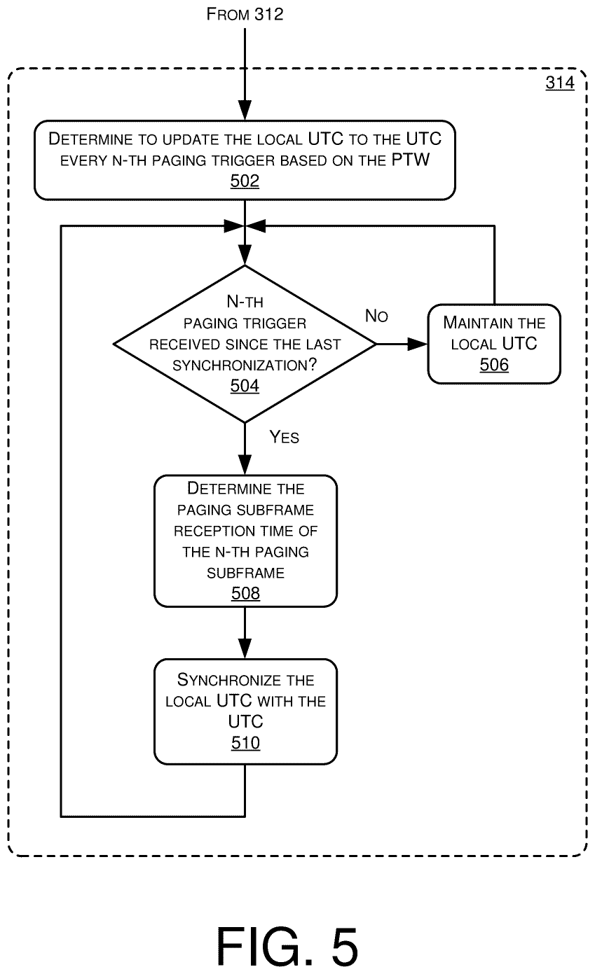

FIG. 5 illustrates example details of block 314 of FIG. 3 for updating the local UTC. At block 502, the first BPD 102 may determine how frequently the local UTC is updated, or synchronized with the UTC, based on the number of paging subframes 124, n, included in the PTW. For example, for n=1, the local UTC may be synchronized with the UTC for every paging trigger 202. However, while a paging trigger 202 may be generated for each corresponding paging subframe 124 received, the local UTC may not need to be synchronized with the UTC for every paging trigger 202 because the reference timer of the first BPD 102 may be known to drift only a small amount that does not require correction over one paging trigger repeat interval 204, and may only need to be synchronized every three paging triggers, for example. For example, n may be set to three, so that the local UTC is synchronized on every third paging trigger 202. Additionally, or alternatively, power consumption of the first BPD 102 may be reduced by updating the local UTC to the UTC every n-th cycles of the paging subframes 124, thus every n-th cycles of the paging triggers 202, instead of every cycle. At block 504, the first BPD 102 may determine whether the n-th paging trigger 202 has been received since last synchronization of the local UTC with the UTC, that is, since registering to the cellular communication network 108 and synchronizing the local UTC to the UTC. In response to determining that the n-th paging trigger 202 has not been received at block 504 (“NO” branch), the reference timer of the first BPD 102 may be unadjusted and the local UTC may remain maintained at block 506, and the process loops back to block 504 till the n-th paging trigger 202 is received. In response to determining that the n-th paging trigger 202 has been received at block 504 (“YES” branch), the first BPD 102 may determine the paging subframe reception time of the n-th paging subframe 124 by subtracting the trigger delay 206 from the trigger time of the n-th paging trigger 202 at block 508. At block 510, the first BPD 102 may adjust the reference timer to synchronize the local UTC with the UTC based on the paging subframe reception time of the n-th paging subframe 124. Additionally, or alternatively, the BPD 102 may determine how much the reference timer has drifted, and may proceed to synchronize the local UTC with the UTC in response to determining that the reference timer has drifted more a preselected minimum threshold amount. The process may then loop back to block 504 to wait for the next n-th paging trigger 202.

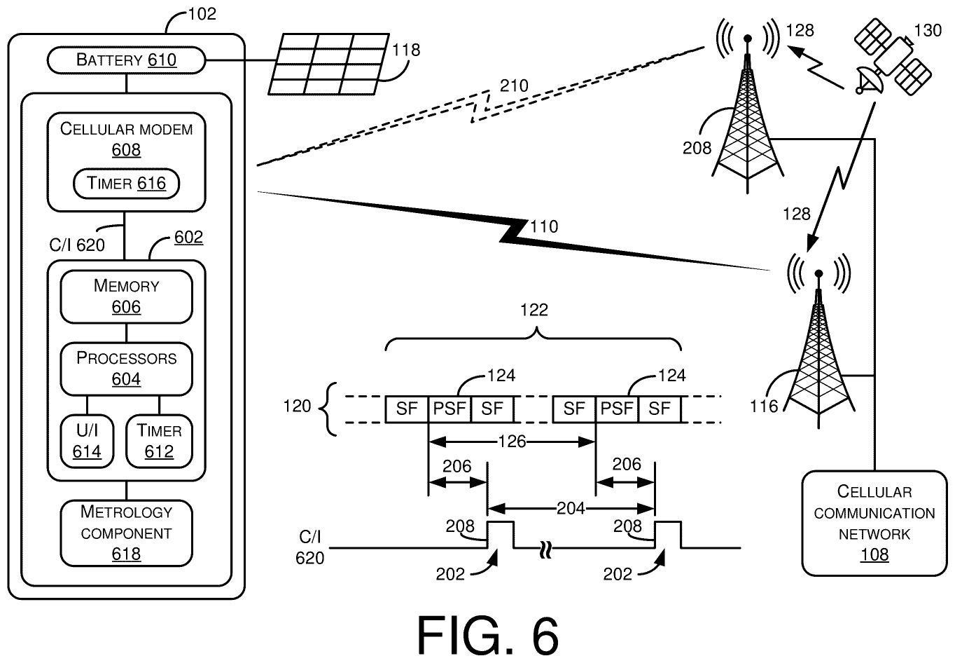

FIG. 6 is a block diagram of a UE, such as the first BPD 102, in a cellular communication network environment. The first BPD 102 may comprise a control unit 602, such as a meter control unit (MCU), which includes one or more processors, or processors, 604, memory 606 communicatively coupled to the processors 604, and a cellular modem 608 communicatively coupled to the control unit 602. The memory 606 may store computer-readable instructions that, when executed by the processors 604, cause the processors 604 to perform operations described above with reference to FIGS. 1-5. The first BPD 102 may be powered by a battery 610 and/or by the solar panel 118 as described above with reference to FIG. 1. The first BPD 102 may also comprise a reference timer 612 coupled to the processors 604, which maintains internal timings associated with performance and functions of the first BPD 102, and user interface (U/I) 614 including input device(s) such as a keyboard, a mouse, a touch-sensitive display, voice input device, etc., and output device(s) such as a display, speakers, a printer, etc. The cellular modem 608 may also comprise a modem reference timer 616 separate from the reference timer 612. The first BPD 102 may additionally comprise a metrology component 618 coupled to the control unit 602. The metrology component 618 may measure volume of gas, water, or other fluid or measurable material passing through the first BPD 102, and report the measurement to the control unit 602 for processing and/or reporting to a central office (not shown) via the cellular modem 608. The metrology component 618 may also be capable of measuring, recording, forwarding to the control unit 602, environmental information surrounding the first BPD 102, such as temperature, humidity, light level, sound level, and other environmental parameters.

For example, the operations may include the first BPD 102 registering to the cellular communication network 108 by communicating with the base station 116 using the cellular modem 608, and receiving, from the base station 116 using the cellular modem 608, the DRX, or eDRX, parameters associated with operating the first BPD 102 in the DRX, or eDRX mode, with the base station 116. The DRX, or eDRX parameters received may be communicated to the control unit 602 from the cellular modem 608 via a communication interface (C/I) 620 and the first BPD 102 may begin operating in the DRX, or eDRX, mode based on the DRX, or eDRX, parameters received from the base station 116. The cellular modem 608 may also communicate the received DRX, or eDRX, parameters via the C/I 620 while the first BPD 102 operates in the DRX, or eDRX, mode. In the eDRX mode, the first BPD 102, more particularly, the cellular modem 608, may wake up at the paging subframe repeat interval 126 based on the eDRX parameters, receive and/or identify the paging subframes 124, and determine whether to be fully active, or booting, to decode data in the paging frames 120. However, while the timing of the paging subframe repeat interval 126 is maintained, or timed, based on the GPS time 128 and thus precise and accurate, clocking, or timing, of internal events of the first BPD 102 is maintained by the reference timer 612 of the first BPD 102, which may drift over time, and the local UTC maintained by the reference timer 612 may no longer be synchronized with the GPS time 128 and/or the UTC.

To correct the reference timer 612, the cellular modem 608 may generate a paging trigger 202 for each paging subframe 124 received, and communicate the paging trigger 202 to the control unit 602 via the C/I 620. As described above with reference to FIG. 1, because the paging subframes 124 are locked to the GPS time 128 and have the accurate time of the GPS time 128, the timing of the paging triggers 202 also has accuracy of the GPS time 128. The first BPD 102 may adjust the reference timer 612 based at least in part on the paging triggers 202. That is, the operations performed by the processors 604 includes updating a local UTC of the reference timer 612 to the UTC by determining the paging subframe reception time of the n-th paging subframe 124 since the last update of the local UTC based at least in part on the paging triggers 202 and the trigger delay 206, as described above with reference to FIG. 5.

As discussed above with reference to FIGS. 2 and 4, the cellular communication network 108 may require the first BPD 102 to switch the base station to access the cellular communication network 108. If the first BPD 102 determines that the base station that the first BPD 102 accesses is switched from the base station 116 to the other base station 208, as shown with the dotted arrow 210, instead of re-registering to the cellular communication network 108 via the different base station 208, the cellular modem 608 may re-establish the DRX, or eDRX, cycle with the different base station 208, generate an indication of the change of the base station, and provide the indication, including the DRX, or eDRX, parameters for the different base station 208 to the control unit 602.

Some or all operations of the methods described above can be performed by execution of computer-readable instructions stored on a computer-readable storage medium, as defined below. The terms “computer-readable medium,” “computer-readable instructions,” “computer-executable instructions,” and “processor-executable instructions” as used in the description and claims, include routines, applications, application modules, program modules, programs, components, data structures, algorithms, and the like. Computer-readable and-executable instructions and processor-executable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (RAM)) and/or non-volatile memory (such as read-only memory (ROM), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media, such as the memory 606, when executed by one or more processors, such as the processors 604, may perform operations described above with reference to FIGS. 1-6. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

### Example Clauses

A. A method performed by an electronic device in a cellular communication network includes: monitoring for paging subframes transmitted at a paging subframe repeat interval; receiving the paging subframes; generating, based at least in part on the paging subframes received, paging triggers having a paging trigger repeat interval equal to the paging subframe repeat interval; and adjusting a reference timer of the electronic device based at least in part on the paging triggers.

B. The method of example A further includes, prior to monitoring the paging subframes: registering to the cellular communication network by communicating with a base station that transmits the paging subframes as an access point, and receiving coordinated universal time (UTC) information from the base station, wherein adjusting the reference timer includes synchronizing a local UTC maintained by the reference timer with UTC.

C. The method of example B further includes: in response to registering to the cellular communication network, receiving, from the base station, discontinuous reception (DRX) parameters associated with operating the electronic device in a DRX mode with the base station, the DRX parameters including enhanced DRX parameters; and operating the electronic device in the DRX mode with the DRX parameters enabling the electronic device to monitor for the paging subframes without fully booting the electronic device including operating the electronic device in the eDRX mode with the eDRX parameters.

D. The method of example C, wherein the DRX mode further enables the electronic device to internally communicate and process the DRX parameters without fully booting the electronic device, the DRX parameters including at least one of: the paging subframe repeat interval, a paging time window (PTW) duration, or a number of paging subframes per PTW.

E. The method of example D further includes: timestamping a rising edge of the paging trigger with a trigger time; and determining a paging subframe reception time of the paging subframe associated with the paging trigger based on the trigger time and a predetermined trigger delay.

F. The method of example E, wherein adjusting the reference timer of the electronic device includes updating the local UTC of the electronic device to the UTC based at least in part on the paging subframe reception time.

G. The method of example E further includes, in response to detecting a change of the access point from the base station to a different base station, generating an indication of the change, the indication including new DRX parameters associated with the different base station, the new DRX parameters include new eDRX parameters associated with the different base station.

H. The method of example G further includes operating the electronic device in the DRX mode with the new DRX parameters including operating the electronic device in the eDRX mode with the new eDRX parameters.

I. An electronic device includes one or more processors; and memory communicatively coupled to the one or more processors, where the memory stores computer executable instructions that, when executed by the one or more processors, cause the one or more processors to perform operations, which include monitoring for paging subframes transmitted at a paging subframe repeat interval in a cellular communication network; receiving the paging subframes; generating, based at least in part on the paging subframes received, paging triggers having a paging trigger repeat interval equal to the paging subframe repeat interval; and adjusting a reference timer of the electronic device based at least in part on the paging triggers.

J. The electronic device of example I, wherein the operations further include, prior to monitoring the paging subframes: registering to the cellular communication network by communicating with a base station that transmits the paging subframes as an access point; and receiving coordinated universal time (UTC) information from the base station, wherein adjusting the reference timer includes synchronizing a local UTC maintained by the reference timer with UTC.

K. The electronic device of example J, wherein the operations further include, in response to registering to the cellular communication network, receiving, from the base station, discontinuous reception (DRX) parameters associated with operating the electronic device in a DRX mode with the base station, the DRX parameters including enhanced DRX parameters; and operating the electronic device in the DRX mode with the DRX parameters enabling the electronic device to monitor for the paging subframes without fully booting the electronic device including operating the electronic device in the eDRX mode with the eDRX parameters.

L. The electronic device of example K, wherein the eDRX mode further enables the electronic device to internally communicate and process the DRX parameters without fully booting the electronic device, the DRX parameters including at least one of: the paging subframe repeat interval, a paging time window (PTW) duration, or a number of paging subframes per PTW.

M. The electronic device of example L, wherein the operations further include timestamping a rising edge of the paging trigger with a trigger time; and determining a paging subframe reception time of the paging subframe associated with the paging trigger based on the trigger time and a predetermined trigger delay.

N. The electronic device of example M, wherein adjusting the reference timer of the electronic device includes updating the local UTC of the electronic device to the UTC based at least in part on the paging subframe reception time.

O. The electronic device of example M, wherein the operations further include, in response to detecting a change of the access point from the base station to a different base station, generating an indication of the change, the indication including new DRX parameters associated with the different base station, the new DRX parameters include new eDRX parameters associated with the different base station; and operating the electronic device in the DRX mode with the new DRX parameters including operating the electronic device in the eDRX mode with the new eDRX parameters.

P. A non-transitory computer-readable storage medium that stores computer executable instructions that, when executed by one or more processors of an electronic device in a cellular communication network, cause the one or more processors to perform operations, which include: monitoring for paging subframes transmitted at a paging subframe repeat interval; receiving the paging subframes; generating, based at least in part on the paging subframes received, paging triggers having a paging trigger repeat interval equal to the paging subframe repeat interval; and adjusting a reference timer of the electronic device based at least in part on the paging triggers.

Q. The non-transitory computer-readable storage medium of example P, wherein the operations further include, prior to monitoring the paging subframes: registering to the cellular communication network by communicating with a base station that transmits the paging subframe as an access point; receiving coordinated universal time (UTC) information from the base station; wherein adjusting the reference timer includes synchronizing a local UTC maintained by the reference timer with UTC, in response to registering to the cellular communication network, receiving, from the base station, discontinuous reception (DRX) parameters associated with operating the electronic device in a DRX mode with the base station, the DRX parameters including enhanced DRX parameters; and operating the electronic device in the DRX mode with the DRX parameters enabling the electronic device to monitor for the paging subframes without fully booting the electronic device including operating the electronic device in the eDRX mode with the eDRX parameters.

R. The non-transitory computer-readable storage medium of example Q, wherein the DRX mode further enables the electronic device to internally communicate and process the DRX parameters without fully booting the electronic device, the DRX parameters including at least one of: the paging subframe repeat interval, a paging time window (PTW) duration, or a number of paging subframes per PTW.

S. The non-transitory computer-readable storage medium of example R, wherein the operations further include: timestamping a rising edge of the paging trigger with a trigger time; determining a paging subframe reception time of the paging subframe associated with the paging trigger based on the trigger time and a predetermined trigger delay; and updating the UTC of the electronic device to the UTC based at least in part on the paging subframe reception time.

T. The non-transitory computer-readable storage medium of example R, wherein the operations further include, in response to detecting a change of the access point from the base station to a different base station, generating an indication of the change, the indication including new DRX parameters associated with the different base station, the new DRX parameters include new eDRX parameters associated with the different base station.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed IS:

1. A method performed by an electronic device in a cellular communication network, the method comprising:
monitoring for paging subframes transmitted at a paging subframe repeat interval;
receiving the paging subframes;
generating, based at least in part on the paging subframes received, paging triggers having a paging trigger repeat interval equal to the paging subframe repeat interval; and
adjusting a reference timer of the electronic device based at least in part on the paging triggers.

2. The method of claim 1, further comprising:
prior to monitoring the paging subframes:
registering to the cellular communication network by communicating with a base station that transmits the paging subframes as an access point, and
receiving coordinated universal time (UTC) information from the base station,
wherein adjusting the reference timer includes synchronizing a local UTC maintained by the reference timer with UTC.

3. The method of claim 2, further comprising:
in response to registering to the cellular communication network, receiving, from the base station, discontinuous reception (DRX) parameters associated with operating the electronic device in a DRX mode with the base station, the DRX parameters including enhanced DRX parameters; and
operating the electronic device in the DRX mode with the DRX parameters enabling the electronic device to monitor for the paging subframes without fully booting the electronic device including operating the electronic device in the eDRX mode with the eDRX parameters.

4. The method of claim 3, wherein the DRX mode further enables the electronic device to internally communicate and process the DRX parameters without fully booting the electronic device, the DRX parameters including at least one of:
the paging subframe repeat interval,
a paging time window (PTW) duration, or
a number of paging subframes per PTW.

5. The method of claim 4, further comprising:
timestamping a rising edge of the paging trigger with a trigger time; and
determining a paging subframe reception time of the paging subframe associated with the paging trigger based on the trigger time and a predetermined trigger delay.

6. The method of claim 5, wherein adjusting the reference timer of the electronic device includes:
updating the local UTC of the electronic device to the UTC based at least in part on the paging subframe reception time.

7. The method of claim 5, further comprising:
in response to detecting a change of the access point from the base station to a different base station, generating an indication of the change, the indication including new DRX parameters associated with the different base station, the new DRX parameters include new eDRX parameters associated with the different base station.

8. The method of claim 7, further comprising:
operating the electronic device in the DRX mode with the new DRX parameters including operating the electronic device in the eDRX mode with the new eDRX parameters.

9. An electronic device comprising:
one or more processors; and
memory communicatively coupled to the one or more processors, the memory storing computer executable instructions that, when executed by the one or more processors, cause the one or more processors to perform operations, the operations comprising:
monitoring for paging subframes transmitted at a paging subframe repeat interval in a cellular communication network;
receiving the paging subframes;
generating, based at least in part on the paging subframes received, paging triggers having a paging trigger repeat interval equal to the paging subframe repeat interval; and
adjusting a reference timer of the electronic device based at least in part on the paging triggers.

10. The electronic device of claim 9, wherein the operations further comprise:
prior to monitoring the paging subframes:
registering to the cellular communication network by communicating with a base station that transmits the paging subframes as an access point; and
receiving coordinated universal time (UTC) information from the base station,
wherein adjusting the reference timer includes synchronizing a local UTC maintained by the reference timer with UTC.

11. The electronic device of claim 10, wherein the operations further comprise:
in response to registering to the cellular communication network, receiving, from the base station, discontinuous reception (DRX) parameters associated with operating the electronic device in a DRX mode with the base station, the DRX parameters including enhanced DRX parameters; and
operating the electronic device in the DRX mode with the DRX parameters enabling the electronic device to monitor for the paging subframes without fully booting the electronic device including operating the electronic device in the eDRX mode with the eDRX parameters.

12. The electronic device of claim 11, wherein the eDRX mode further enables the electronic device to internally communicate and process the DRX parameters without fully booting the electronic device, the DRX parameters including at least one of:
the paging subframe repeat interval,
a paging time window (PTW) duration, or
a number of paging subframes per PTW.

13. The electronic device of claim 12, wherein the operations further comprise:
timestamping a rising edge of the paging trigger with a trigger time; and
determining a paging subframe reception time of the paging subframe associated with the paging trigger based on the trigger time and a predetermined trigger delay.

14. The electronic device of claim 13, wherein adjusting the reference timer of the electronic device includes:
updating the local UTC of the electronic device to the UTC based at least in part on the paging subframe reception time.

15. The electronic device of claim 13, wherein the operations further comprise:
in response to detecting a change of the access point from the base station to a different base station, generating an indication of the change, the indication including new DRX parameters associated with the different base station, the new DRX parameters include new eDRX parameters associated with the different base station; and
operating the electronic device in the DRX mode with the new DRX parameters including operating the electronic device in the eDRX mode with the new eDRX parameters.

16. A non-transitory computer-readable storage medium storing computer executable instructions that, when executed by one or more processors of an electronic device in a cellular communication network, cause the one or more processors to perform operations, the operations comprising:
monitoring for paging subframes transmitted at a paging subframe repeat interval;
receiving the paging subframes;
generating, based at least in part on the paging subframes received, paging triggers having a paging trigger repeat interval equal to the paging subframe repeat interval; and
adjusting a reference timer of the electronic device based at least in part on the paging triggers.

17. The non-transitory computer-readable storage medium of claim 16, wherein the operations further comprise:
prior to monitoring the paging subframes:
registering to the cellular communication network by communicating with a base station that transmits the paging subframe as an access point;
receiving coordinated universal time (UTC) information from the base station;
wherein adjusting the reference timer includes synchronizing a local UTC maintained by the reference timer with UTC,
in response to registering to the cellular communication network, receiving, from the base station, discontinuous reception (DRX) parameters associated with operating the electronic device in a DRX mode with the base station, the DRX parameters including enhanced DRX parameters; and
operating the electronic device in the DRX mode with the DRX parameters enabling the electronic device to monitor for the paging subframes without fully booting the electronic device including operating the electronic device in the eDRX mode with the eDRX parameters.

18. The non-transitory computer-readable storage medium of claim 17, wherein the DRX mode further enables the electronic device to internally communicate and process the DRX parameters without fully booting the electronic device, the DRX parameters including at least one of:
the paging subframe repeat interval,
a paging time window (PTW) duration, or
a number of paging subframes per PTW.

19. The non-transitory computer-readable storage medium of claim 18, wherein the operations further comprise:
timestamping a rising edge of the paging trigger with a trigger time;
determining a paging subframe reception time of the paging subframe associated with the paging trigger based on the trigger time and a predetermined trigger delay; and
updating the UTC of the electronic device to the UTC based at least in part on the paging subframe reception time.

20. The non-transitory computer-readable storage medium of claim 18, wherein the operations further comprise:
in response to detecting a change of the access point from the base station to a different base station, generating an indication of the change, the indication including new DRX parameters associated with the different base station, the new DRX parameters include new eDRX parameters associated with the different base station.
